(19) United States
(12) Patent Application Publication
(10) Pub. No.: US 2009/0233104 A1
(43) Pub. Date: Sep. 17, 2009

(54) Process for Making Composite Products

(76) Inventors: Mizi Fan, Watford (GB); Peter William Bonfield, Codicote (GB)

Correspondence Address: CHRISTIE, PARKER & HALE, LLP, PO BOX 7068, PASADENA, CA, 91109-7068, US

(21) Appl. No.: 12/225,608

(22) PCT Filed: Mar. 23, 2007
(86) PCT No.: PCT/GB2007/050144

§ 371 Date: Feb. 26, 2009

(30) Foreign Application Priority Data
Mar. 25, 2006 (GB) 0606065.1

(51) Int. Cl. B32B 17/10; B29C 69/00

(52) U.S. Cl. 428/430; 264/241

(57) ABSTRACT

A process for making composite products such as doors comprises the steps of: i) forming a mass of plant fibres; ii) coating the mass of plant fibres with at least one resin and at least one catalyst without agitating the mass of plant fibres; iii) compacting the coated mass of plant fibres; and iv) curing the compacted mass of plant fibres; wherein the process also comprises the step of drying the plant fibres either before and/or after step ii).

The present invention relates to a process for making composite products. In particular, it relates to a process for making composite products from plant fibres, and to the composite products made by this process. These products are preferably laminated composite products.

Plant fibres are natural products that have many uses; for example, they are used to make fabric for clothing or carpets, or are used to make rope. Examples of such plant fibres are flax, hemp and jute. These plant fibres are readily available. They are also easy to produce agriculturally and are relatively cheap as a raw material. Plant fibres come in many forms and may be the main product of a crop, or a by-product.

Plant fibres have been used in composite products for many years as fillers: the fibres are broken down into a powder form and made into a paste; or they are made into a pulp and ground. Since the plant fibres are broken down into very small pieces (forming, for example, a fibre flour), the resulting composite products can be made using processes such as extrusion moulding or die moulding. These processes are used for moulding a material that is single layer and has a uniform distribution of constituents.

A composite product is a complex material in which two or more distinct substances, such as glass and polymers, combine to produce structural or functional properties not present in any individual component.

The present invention seeks to provide a process for making composite products from plant fibres that retain at least some of their fibrous nature.

According to the present invention, there is provided a process for making composite products comprising:

a) adding at least one resin and at least one catalyst to plant fibres;
b) compacting the resulting mixture; and
c) curing the mixture;
wherein the process also comprises the step of drying the plant fibres either before and/or after step a).

According to the present invention, there is also provided a process for making composite products comprising:

i) forming a mass of plant fibres;
ii) coating the mass of plant fibres with at least one resin and at least one catalyst without agitating the mass of plant fibres;
iii) compacting the coated mass of plant fibres; and
iv) curing the compacted mass of plant fibres;
wherein the process also comprises the step of drying the plant fibres either before and/or after step ii).

In this process, the mass of plant fibres is not disturbed (not agitated) when the resin and catalyst are added. This means that the plant fibres are not stirred or otherwise mixed with the resin and catalyst, for example. The plant fibres therefore remain substantially fixed in their mass arrangement.

This process uses plant fibres. Fibres are slender and elongate solid substances. They are long. The process of the present invention does not use plant fibre flour, which is produced by grinding, pulverising or otherwise breaking down the plant fibres into fragments.

In the process, the plant fibres are coated with the resin. The process of the invention is able to produce both single layer and multi-layers products. The fibres may be oriented in the resulting product to achieve specific properties in the required direction.

The process of the present invention does not use extrusion moulding or die moulding, since this is not possible using plant fibres (in contrast to plant fibre flour).

The process of the present invention preferably substantially retains the integrity of the plant fibres so that their inherent strength can be utilised.

Preferably no wood waste is used in the process, examples of wood waste being dust, chips and small scraps.

The plant fibres are preferably in the form of mats in step a) and step ii).

The resin may be a phenolic resin or a polyester resin. The plant fibres may be selected from the group consisting of hemp, jute and flax. Preferably, the plant fibres are dried to a moisture content of 0 to 1% by weight before step a) and step ii). The plant fibre may be soaked in the resin in step a) and step ii).

The plant fibres used in the process of the present invention preferably have a length of between 4 mm and 40 mm, depending on the type of plant fibre used. Hemp fibres preferably have a length of between 5 mm and 25 mm. Flax fibres preferably have a length of between 20 mm and 40 mm. Jute fibres preferably have a length of between 4 mm and 15 mm.

Preferably, the compacting step comprises pressing the mixture and/or rolling the mixture. The compacting step may be carried out at an elevated temperature.

The composite product prepared by the process of the present invention is preferably a laminated composite product. It may be a construction, insulation or packaging product. In one example, it is a door.

The composite product is particularly useful as a construction product. This is because the process of the present invention substantially retains the length and therefore the strength of the fibres and permits a high fibre content, meaning that the resulting product can be both lightweight and strong.

The composite product may comprise 25 to 85% by weight plant fibres and 15 to 75% by weight resin. It may be a phenolic-plant fibre composite or a polyester-plant fibre composite. It may comprise at least one layer of resin-plant fibre composite and, optionally, at least one layer of resin-glass fibre composite. It may be provided with one or more surface treatments selected from the group consisting of painting and coating with resin (for example, gel coating).

The use of plant fibres in the manufacture of composite products and to replace glass fibres in resin-fibre composites is disclosed.

The composite products manufactured using the process of the present invention may be tailored to have specific properties and may be subjected to further processing. The process of the present invention allows high volume production of composite products.

Embodiments of the present invention will now be described, by way of example only.

Starting Materials

### 1. Resins

### a) Phenolic Resin Plus Phencat Catalyst

Liquid phenolic resin J2027L was obtained from Borden Chemical UK Limited. Phencat 382 was supplied with the phenolic resin. It is a blend of organic and inorganic acids. Phenolic resin has fire resistance properties.

### b) Crystic 2-406PA Polyester Resin Plus Catalyst M

Polyester resin was obtained from Scott Bader Company Limited. It is a pre-accelerated, thixotropic polyester resin, with low styrene emission. The catalyst M was supplied together with the polyester resin.

### 2. Plant Fibres

The plant fibres used were hemp (Cannabis sativa), jute (Corchorus sp.) and flax (Linum usitatissimum). They were obtained from a plant fibre company in the form of mats. The fibre mats were stored at 20° C. and 65% relative humidity (rh) before use. At this relative humidity, samples of these plant fibres were found to have a moisture content of about 10 to 13% by weight.

The inventors found that the plant fibres required drying during processing to reduce the formation of voids in the composites. This is because excess moisture in the composite mixture turned to steam during any processing step occurring at an elevated temperature, such as the step of hot pressing. The formation of voids is not desirable as it reduces the strength of the product, since it is not uniformly compact.

Drying 100×100 mm samples of flax, hemp and jute fibre mats at about 100° C. for about one hour was found to dry them sufficiently for processing, with large amounts of water being driven off in the first twenty minutes.

The properties of hemp, jute and flaxfibres in the fibre mats used was as follows:

| | | | | | Tensile | |
|---|---|---|---|---|---|---|
| | Density | Moisture | Length | Diameter | strength | Young's |
| | (kg/m3) | content (%) | (mm) | (um) | (Mpa) | modulus (Gpa) |
| Hemp fibre | 1468 | 11.5 | 9.7-17.2 | 22.4-28.3 | 382-826 | 38-58 |
| Flax fibre | 1533 | 11.8 | 25.6-34.8 | 15.2-22.2 | 520-859 | 45-68 |
| Jute fibre | 1492 | 13.2 | 5.8-11.4 | 11.2-18.2 | 300-621 | 39-63 |

### Curing of Phenolic Resin

The chemical cross-linking of phenolic resin is exothermic and releases water. An intensive exothermic reaction may heat the release water to boiling point. This water moves to the surface of boards during pressing. The state of the water and the stage of resin curing when the water is moving through the board has a considerable effect on the properties of the composite.

An experiment on resin curing was carried out to determine the effect of the curing process on the formation of voids.

Phenolic resin was mixed with 1%, 3% and 5% catalyst by weight respectively. About 6 g of each mixture was put into a foil container. The containers were transferred to ovens for 16 hours at 60° C., followed by 4 hours at 100° C., then 24 hours at 100° C. and finally 1 week at 100° C. The reaction process and the mass of resin were monitored. The curing process and the percentage of mass change of the mixtures are summarised in Table 1.

TABLE 1
Curing process and the percentage of weight loss
(% of original weight) of phenolic resin

| Test | Test 1 | Test 2 | Test 3 |
|---|---|---|---|
| Catalyst | 1% | 3% | 5% |
| At 60° C. (16 hrs) | uncured | cured | cured |
| At 100° C. (4 hrs) | cured | cured | cured |
| Weight loss after 60° C. and 100° C. | 17.9% | 4.8% | 2.7% |
| Total weight loss after 16 hours at 60° C., | 19.5% | 6.75% | 4.65% |
| 4 hours at 100° C. and further 24 hrs | | | |
| at 100° C. | | | |
| Total weight loss after 16 hours at 60° C., | 24.2% | 23.0% | 21.4% |
| 4 hours at 100° C., 24 hrs at 100° C. and | | | |
| further 1 week at 100° C. | | | |

The inventors found that the level of catalyst strongly influenced the curing process of the phenolic resin. A higher (≧3% by weight) percentage of catalyst resulted in a faster curing reaction, even at 60° C.; from the table above, it can be seen that the resin mixed with 3 and 5% catalyst cured within 16 hours at a temperature of 60° C., whereas the resin mixed with 1% catalyst remained uncured under these conditions.

When the volume of moisture lost is high at an early stage of the curing reaction, further drying will result in large voids inside the composite.

A fast curing process may not give enough time for the released water to be fully evaporated from inside the board to the surface of the board. Such water will be embedded in the composite, and further drying will leave voids in the composite.

Table 1 shows that, after 4 hours of drying, the weight loss is only about 5% for the resin with 3% catalyst and 3% for that with 5% catalyst. In contrast, although the resin with 1% catalyst could not cure at 60° C., it cured at 100° C. and the weight loss after curing was about 18%, which is about 4 times the level for the mixtures containing either 3 or 5% catalyst.

Thus, an increase in temperature will result in a fast reaction of the resin, but this also results in large size voids which is detrimental to the mechanical properties and the surface appearance of the composite.

There is very similar weight loss after final drying. This again indicates that the final products have the same solid content, whilst having very different structures and therefore performance.

The results show that control of the catalyst content and curing temperature is required to provide a composite having good performance.

### A. Phenolic-Plant Fibre Composites

Three composites were made using flax fibre mats, these composites being a low density phenolic-plant fibre composite (M1), a high density phenolic-plant fibre composite (M2) and a medium density clear colour phenolic-plant fibre composite (M3). The experimental details are summarised in the table below.

TABLE 2
Experimental parameters for flax-phenolic composites

| | | | | Catalyst | |
|---|---|---|---|---|---|
| Material | Fibre type | Layer | Pre-dried | (% weight) | Pressing* |
| M1 | Flax | 1 | Yes | 6 | A |
| M2 | Flax | 2 | No | 3 | B |
| M3 | Flax | 2 | Yes | 2 | C |

*A, B, C = various pressing parameters: A: T = 165° C.; P = 7 kg/cm²; t = 1.0 min/mm B: T = 145° C.; P = 12 kg/cm²; t = 1.5 min/mm C: T = 125° C.-85° C.; P = 10 kg/cm²; t = 1.8 min/mm
Where
T = temperature,
P = pressure;
t = time

Drying the raw fibre mats: Three flax mats were cut into 600×600 mm samples. Two were oven dried at 100±3° C. for one hour before use.
Soaking: The different percentages of Phencat catalyst given in Table 2 were used to obtain composites with a range of properties. Phenolic resin was mixed with the catalyst, and the flax fibre mats were soaked with the mixed resin.
Drying the soaked fibre mat: The soaked fibre mats were put into oven at 60° C. for 3 hours. This was to reduce the amount of moisture loss.
Formatting: The pre-dried fibre mats were laid on a flat panel mould, and transferred to the hot press.
Pressing: Three hot press procedures, namely A, B and C (see Table 2), were investigated depending on the moisture content of the fibre mats, and the structure and appearance (colour) of the composites. Hot pressing was used, rather than pressing at room temperature, in order to shorten the pressing time. This pressing cured the products.
Property evaluation: Panels were cut into the appropriate size for assessment in accordance with British Standards (BS), which are European Harmonised Standards (EN). The modulus of elasticity (MOE) and modulus of rupture (MOR) were determined on samples tested in flexure using a three-point bending apparatus in accordance with BSEN310. Thickness swelling after water immersion was determined in accordance with BSEN317, and the density of the composites was determined in accordance with BSEN323.

The results for the various composites are given in Table 3. All values are the average of 10 test pieces. It can be seen that both fibre content and the experimental parameters influenced the properties of the phenolic-plant fibre composites.

TABLE 3
Main properties of phenolic-plant fibre composites

| | | | | | | | Thickness |
|---|---|---|---|---|---|---|---|
| | | Thick- | | | | Fibre | content |
| | Fibre | ness | Density | MOR | MOE | (% | swelling |
| Material | type | (mm) | (kg/m3) | (MPa) | (GPa) | weight) | (%) |
| M1 | Flax | 3.56 | 353 | 22.29 | 4.15 | 45.10 | 0.52 |
| M2 | Flax | 4.71 | 1197 | 68.20 | 5.85 | 32.12 | 0.10 |
| M3 | Flax | 4.31 | 806 | 56.18 | 6.21 | 32.91 | 0.11 |

These experiments demonstrate that plant fibres can be used to reinforce phenolic resin. A range of plant fibre reinforced composites were successfully made with the phenolic resin.

Drying of the soaked fibre mats allowed reductions in both pressing temperature and time for composite manufacture, and the properties of the composites made from these fibres were improved due to a reduction in both size and number of voids and increased opportunities for bonding.

The inventors found that the percentage of catalyst used, the curing temperature, the pressure and the curing time all influenced the curing process and the appearance and properties of the composites formed. The chemical reactions taking place can be controlled to dictate the colour of the end product to a certain extent.

Also, the inventors found that the dried plant fibre mats had a tendency to absorb moisture. This was found to be beneficial in the manufacture of phenolic composites because it reduced the emission of water released by the cross-linking reaction of the resin in a hot press step.

In some products, such as vehicular bodies, roofing and building products (eg arches and pillars), composites of glass fibre and phenolic resin are used. The present inventors have found that plant fibres are more compatible with phenolic resin than glass fibres are. This is possibly because the lignin component of plant fibres is phenolic, and strong covalent bonds can therefore be made between plant fibres and phenolic resins.

### B. Polyester-Plant Fibre Composites

Experiments were conducted to explore the opportunity of using plant fibres to replace (partly or completely) glass fibres in composites for construction use. A polyester resin was chosen. Hemp, jute and glass fibre polyester composites were produced as thick panels.

Fibre preparation: Hemp, jute and glass fibres were cut into 600×600 mm mats. The plant fibre mats were oven-dried before use.
Polyester resin: Crystic 2-406PA polyester was mixed with 1.5% Catalyst M.
Lay-up and moulding: The mixed polyester was applied to the fibre mats by using a roller one layer at a time. A mould was used to lay-up the composites. The mould containing the uncured composite mat was moved into a cold press and a very low pressure was applied for about 8 hours, where the mat was cured.

### Resin Controls

Control samples of 100% polyester resin were made in thicknesses of 3.5 and 18 mm.

### Hemp-Polyester Composites

Thin panels with a nominal thickness of 3.5 mm were made to determine the efficacy of replacement of glass fibres with plant fibres. Hemp fibre mats were used. A range of compositions were made as follows:
3 layers hemp (H+H+H=3H)
2 layers hemp+1 layer glass fibre (H+G+H=2H+1G)
1 layer hemp+2 layers glass fibre (G+H+G=2G+1H)
3 layers glass fibre (G+G+G=3G)
Where G=glass fibre and H=hemp fibre

### Jute-Polyester Composites

Thicker panels with a nominal thickness of 18 mm were also made. Jute fibre mats were used and a series of composites were made as follows:
9 layers glass fibre (G+G+G+G+G+G+G+G+G=9G)
1 layer Jute+8 layer glass fibre (G+G+G+G+J+G+G+G+G=8G+1J)
2 layers jute+7 layers glass fibre (G+G+G+J+G+J+G+G+G=7G+2J)
3 layers jute+6 layers glass fibre (G+G+J+G+J+G+J+G+G=6G+3J)
4 layers jute+5 layers glass fibre (G+J+G+J+G+J+G+J+G=5G+4J)
Where J=jute fibre and G=glass fibre
Property evaluation: Samples were tested according to the relevant standards for bending strength (Modulus of Rupture MOR) and stiffness (Modulus of Elasticity MOE) and impact resistance (IR). Ten replicates were tested

TABLE 4
Properties of hemp-polyester composites

| Material | MOR (MPa) | MOE (GPa) | IR |
|---|---|---|---|
| 3G | 152.03 | 9.36 | 301.62 |
| 2G + 1H | 120.21 | 7.52 | 301.62 |
| 2H + 1G | 92.29 | 3.34 | 279.17 |
| 3H | 79.86 | 4.02 | 133.56 |
| Resin | 41.92 | 1.83 | 56.75 |

TABLE 5
Properties of jute-polyester composites

| Material | MOR (MPa) | MOE (GPa) |
|---|---|---|
| Resin | 41.92 | 1.83 |
| 9G | 195.78 | 6.81 |
| 8G + 1J | 223.27 | 10.57 |
| 7G + 2J | 148.97 | 10.94 |
| 6G + 3J | 152.95 | 11.36 |
| 5G + 4J | 134.11 | 15.28 |

It can be seen that the inclusion of plant fibres improved the properties of the polyester resin.

For 3 mm composites, both MOR and MOE decreased as the percentage of hemp fibre substitution for glass fibre increased. However, replacement with one or two layers of hemp fibres caused only a slight reduction in impact resistance.

Increasing the percentage of plant fibre substitution did not greatly affect the MOR of the jute and glass fibre reinforced composites, while it resulted in a consistent increase in MOE, possibly due to a higher bond strength between the jute fibres and the polyester, and the difference in stiffness of the jute and glass fibres.

It can be concluded that there is great potential for replacing glass fibre with plant fibres to produce structural composites (thick panels), reducing both the cost and density of the composites without sacrificing performance.

### C. Polyester-Plant Fibre Composite Doors

The present inventors have manufactured hemp-polyester doors and jute-polyester doors. Three layers of hemp (3H) were used for hemp-polyester door. One layer of jute was used for jute-polyester door.

Fibre preparation: Hemp and jute were cut into 800×1900 mm mats. The plant fibre mats were oven-dried before use.
Polyester resin: Crystic 2-406PA polyester was mixed with 1.5% Catalyst M.
Lay-up and moulding: The mixed polyester was applied to the fibre mats by using a roller one layer at a time. A door-skin mould was used to lay-up the composites. The mould containing the uncured composite mat was linked to a vacuum unit and cold-vacuum-pressed for about 8 hours, where the mat was cured.
A control door (glass fibre polyester) was made using the same process.
Door performance: The hemp fibre-polyester and glass fibre-polyester doors were tested as external doors. External doors can twist or bow in service. This results from a combination of climatic conditions and door construction.
Hygrothermal and thermal distortion tests were carried out in accordance with Tests 10 and 11 of the British Standard DD171:1987. The distortion (bow) of hinge, lock, top and bottom sides of both the hemp fibre and the glass fibre composite doors was similar: the distortion was visually insignificant and well below the maximum allowable value of 10 mm under both tests.

1. A process for making composite products comprising:
a) adding at least one resin and at least one catalyst to plant fibres;
b) compacting the resulting mixture; and
c) curing the mixture;
wherein the process also comprises the step of drying the plant fibres either before and/or after step a).

2. A process for making composite products comprising:
i) forming a mass of plant fibres;
ii) coating the mass of plant fibres with at least one resin and at least one catalyst without agitating the mass of plant fibres;
iii) compacting the coated mass of plant fibres; and
iv) curing the compacted mass of plant fibres;
wherein the process also comprises the step of drying the plant fibres either before and/or after step ii).

3. A process as claimed in claim 1 or claim 2, wherein plant fibres are in the form of mats in step a) or step ii).

4. A process as claimed in claim 3, wherein the resin is a phenolic resin or a polyester resin.

5. A process as claimed in claim 3, wherein the plant fibres are selected from the group consisting of hemp, jute and flax.

6. A process as claimed in claim 3, wherein the plant fibres are dried to a moisture content of 0 to 1% by weight before step a) or step ii).

7. A process as claimed in claim 3, wherein the plant fibre is soaked in the resin in step a) or step ii).

8. A process as claimed in claim 3, wherein the compacting step comprises pressing and/or rolling the mixture.

9. A process as claimed in claim 8, wherein the compacting step is carried out at an elevated temperature.

10. A composite product prepared by the process of claim 3.

11. A composite product as claimed in claim 10 comprising 25 to 85% by weight plant fibres.

12. A composite product as claimed in claim 10 comprising 15 to 75% by weight resin.

13. A composite product as claimed in claim 10 being a phenolic-plant fibre composite or a polyester-plant fibre composite.

14. A composite product as claimed in claim 10 being provided with one or more surface treatments selected from the group consisting of painting and coating with resin.

15. A composite product as claimed in claim 10 comprising at least one layer of resin-plant fibre composite and, optionally, at least one layer of resin-glass fibre composite.

16. A composite product as claimed in claim 10 being a door.

17. (canceled)

18. (canceled)

19. (canceled)

20. (canceled)

21. (canceled)

22. (canceled)
